(19) United States
(12) Patent Application Publication
(10) Pub. No.: US 2026/0312192 A1
(43) Pub. Date: Oct. 8, 2026

(54) SECONDARY BATTERY

(71) Applicant: KABUSHIKI KAISHA TOSHIBA, Kawasaki-shi (JP)

(72) Inventor: Ken CHIKANO, Yokohama Kanagawa (JP)

(73) Assignee: KABUSHIKI KAISHA TOSHIBA, Kawasaki-shi (JP)

(21) Appl. No.: 19/558,746

(22) Filed: Mar. 6, 2026

(30) Foreign Application Priority Data
Apr. 8, 2025 (JP) 2025-063693

(51) Int. Cl. H01M 50/15; H01M 50/103; H01M 50/474; H01M 50/533; H01M 50/55; H01M 50/557

(52) U.S. Cl. CPC H01M 50/15; H01M 50/103; H01M 50/474; H01M 50/533; H01M 50/55; H01M 50/557

(57) ABSTRACT

According to one embodiment, there is provided a secondary battery that includes an outer case including an aperture portion, and an electrode assembly in the outer case, and a lid member disposed at the aperture portion and having a first through-hole, and a conductive member disposed between the electrode assembly and the lid member and having a substrate portion provided with a second through-hole, and a terminal having a shaft portion in the first through-hole and the second through-hole, and a first insulating member having a first flange portion disposed on a lower side of the lid member and a second flange portion disposed on an upper side of the lid member. The substrate portion of the conductive member includes a top portion that is in contact with the first flange portion.

This application is based upon and claims the benefit of priority from Japanese Patent Application No. 2025-063693, filed Apr. 8, 2025, the entire contents of which are incorporated herein by reference.

### FIELD

Embodiments described herein relate generally to a secondary battery.

### BACKGROUND

In recent years, secondary batteries such as lead-acid batteries and nickel-metal hydride batteries have been used as power sources represented by electric vehicles, hybrid vehicles, electric motorcycles, forklifts, and the like. Recently, development toward adoption of a lithium-ion secondary battery having a high energy density has been actively conducted, and development has been conducted in consideration of long life, safety, and the like.

A general lithium-ion secondary battery (hereinafter simply referred to as “secondary battery”) may be manufactured by housing an electrode assembly inside an outer case. In some cases, a terminal is disposed in the through-hole of the lid member with an insulating member, and in such cases, hermeticity between the lid member and the terminal is ensured by the insulating member.

However, when an external impact is applied to the secondary battery, the insulating member may become loosened and hermeticity between the lid member and the terminal may not be maintained. Examples of external impacts include vibration generated during the operation of a vehicle equipped with the secondary battery. Furthermore, when multiple secondary batteries are connected, a connection member may be attached to the terminal. Vibration generated during attachment of the connection member may also loosen the insulating member, resulting in a loss of hermeticity between the lid member and the terminal. Consequently, hermeticity of the secondary battery may not be ensured.

### BRIEF DESCRIPTION OF THE DRAWINGS

FIG. 1 is a perspective view schematically showing a secondary battery of a first embodiment.

FIG. 2 is an exploded perspective view schematically showing the secondary battery of the first embodiment in a state disassembled by component.

FIG. 3 is a cross-sectional view of the region around the terminal along line I-I in FIG. 1 and viewed from the direction of the arrows.

FIG. 4 is an enlarged cross-sectional view of the top portion of the first substrate portion in FIG. 3.

FIG. 5 is a cross-sectional view of the region around the terminal along line I-I in FIG. 1 and viewed from the direction of the arrows for a modified example.

FIG. 6 is a cross-sectional view of the region around the terminal along line I-I in FIG. 1 and viewed from the direction of the arrows for a comparative example.

### DETAILED DESCRIPTION

In general, according to one embodiment, there is provided a secondary battery that includes an outer case including an aperture portion, and an electrode assembly in the outer case, and a lid member disposed at the aperture portion and having a first through-hole, and a conductive member disposed between the electrode assembly and the lid member and having a substrate portion provided with a second through-hole, and a terminal having a shaft portion in the first through-hole and the second through-hole, and a first insulating member having a first flange portion disposed on a lower side of the lid member and a second flange portion disposed on an upper side of the lid member. The substrate portion of the conductive member includes a top portion that is in contact with the first flange portion.

Hereinafter, a secondary battery according to an embodiment will be described with reference to the drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc. of the respective parts are schematically illustrated in the drawings, compared to the actual modes. However, the schematic illustration is merely an example and adds no restrictions to the interpretation of the invention. In addition, in the specification and drawings, the same elements as those described in connection with preceding drawings are denoted by like reference numbers, and detailed description thereof is omitted or simplified unless necessary.

### First Embodiment

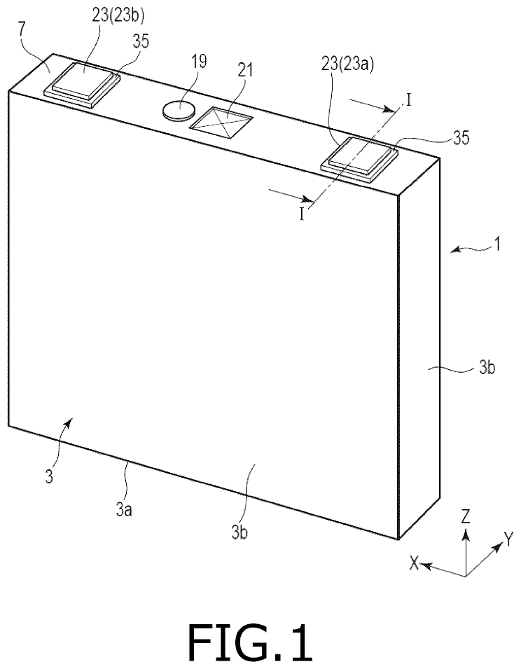

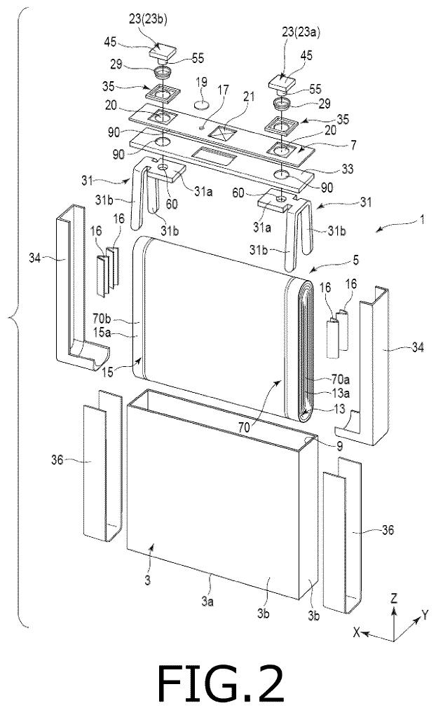

A secondary battery 1 of a first embodiment will be described with reference to FIGS. 1 and 2. FIG. 1 is a perspective view schematically showing a secondary battery according to the first embodiment. FIG. 2 is an exploded perspective view schematically showing the secondary battery of the first embodiment in a state disassembled by component.

In the figures, the width direction of the outer case is referred to as the X-direction, the height direction (the direction in which the electrode assembly is inserted) is referred to as the Z-direction, and the thickness direction orthogonal to these is referred to as the Y-direction.

As shown in FIGS. 1 and 2, the secondary battery 1 includes an outer case 3 and an electrode assembly 5 inside the outer case 3. For example, the outer case 3 has a tubular shape with a bottom wall 3a and side walls 3b. A tubular shape usually has circular, square or rectangular sections, although other shaped sections are possible. The outer case 3 includes an aperture portion 9, and a lid member 7 with a first through-hole 20 is disposed at the aperture portion 9. The outer case 3 and the lid member 7 are formed of a metal such as aluminum, aluminum alloy, iron, copper, or stainless steel. The secondary battery 1 only needs to include the outer case 3 and the electrode assembly 5, and therefore the bottom wall 3a and the aperture portion 9 are not limited to a rectangular shape, and the outer case 3 is not limited to a tubular shape.

As shown in FIG. 2, the electrode assembly 5 is manufactured, for example, by winding a separator (not shown) between the positive electrode 13 and the negative electrode 15 around an axis and then pressing the whole to form a flat shape. The positive electrode 13 includes a positive current collector 13a and a positive active material layer (not shown) supported on the positive current collector 13a. A region of the positive current collector 13a where the positive active material layer is not coated serves as a positive current collector tab 70a. Similarly, the negative electrode 15 includes a negative current collector 15a and a negative active material layer (not shown) supported on the negative current collector 15a. A region of the negative current collector 15a where the negative active material layer is not coated serves as a negative current collector tab 70b. The positive current collector tab 70a and the negative current collector tab 70b are sometimes collectively referred to as current collector tabs 70.

The electrode assembly 5 is not limited to the wound structure described above; it may also have a stacked structure in which multiple positive electrodes 13 and multiple negative electrodes 15 are alternately laminated with separators interposed therebetween. Furthermore, the electrode assembly 5 is not limited to a wound structure or a stacked structure. When a stacked-type electrode assembly 5 is employed instead of a wound structure, the connection structure with the outer case 3 is modified as appropriate.

In the present embodiment, the electrode assembly 5 is a wound structure, and multiple layers of the current collector tabs 70 are disposed at least at one end of the electrode assembly 5, extending from the positive electrode 13 and the negative electrode 15. In this embodiment, the positive current collector tab 70a extends in the opposite direction to the negative current collector tab 70b. That is, the current collector tabs 70 are disposed at both ends in the direction of winding axis of the electrode assembly 5 and extend in a direction orthogonal to the insertion direction (the Z-direction) of the electrode assembly 5 into the outer case 3. However, the extending directions of the positive current collector tab 70a and the negative current collector tab 70b are not limited to these configurations. For example, both tabs 70 may extend in the same direction and be disposed at one end of the electrode assembly 5.

When the electrode assembly 5 having the wound structure is used and the wound current collector tabs 70 are disposed at both ends in the direction of the winding axis as in the present embodiment, the ends of the current collector tabs 70 are preferably clamped by two or more metal members 16. Here, clamping refer to the metal member 16 bundling and integrating the plurality of current collector tabs 70. At least part of the metal member 16 needs to contact one face and the other face of the current collector tab 70.

Stable clamping of the current collector tabs 70 by the metal members 16 is thereby achieved even when, for example, the weight of the electrode assembly 5 is increased as a means of increasing the capacity of the secondary battery 1. Here, increasing the weight of the electrode assembly 5 includes enlarging the dimensions of the electrode assembly or increasing the number of windings of the electrodes to increase the mass of the electrode active material. The number of the metal members 16 disposed for each of the current collector tabs 70 at the respective ends of the electrode assembly 5 is not limited to these examples. At least one of the current collector tabs 70 at the respective ends of the electrode assembly 5 is preferably clamped by one or more metal members 16.

In the secondary battery 1 of this embodiment, a conductive member 31 having a first substrate portion 31a with a second through-hole 60 is disposed between the electrode assembly 5 and the lid member 7. The conductive member 31 includes two second substrate portions 31b connected to the first substrate portion 31a; however, the number of second substrate portions 31b is not limited to two. It is preferable that each second substrate portion 31b of the conductive member 31 be joined to a metal member 16 that clamps the current collector tabs 70, thereby electrically connecting the electrode assembly 5 and the terminal 23. When the conductive member 31 is joined to the metal member 16, tearing of the current collector tabs 70 at the time of joining can be suppressed in comparison with directly joining the conductive member 31 to the tabs 70. Here, the terminal 23 connected to the positive current collector tab 70a is referred to as the positive terminal 23a, and the terminal 23 connected to the negative current collector tab 70b is referred to as the negative terminal 23b. The conductive member 31 is preferably provided as a pair separated on the positive-electrode side and the negative-electrode side, but may alternatively be provided only on one side.

The shaft portion 55 of the terminal 23 is disposed within the first through-hole 20 of the lid member 7 and in the second through-hole 60 of the conductive member 31. The terminal 23 is formed of a conductive material such as metal, and its shaft portion 55 is fitted in close contact with the lid member 7 and the conductive member 31 with a circular insulating gasket 29 (first insulating member). When bringing the shaft portion 55, the first insulating gasket 29, and the lid member 7 into close contact, a load is applied to a head portion 45 of the terminal 23 connected to the shaft portion 55, thereby crimping the shaft portion 55 to the lid member 7. The positional relationship between the first through-hole 20 of the lid member 7 and the second through-hole 60 of the conductive member 31 is aligned in the insertion direction (the Z-direction) of the electrode assembly 5 into the outer case 3.

In the secondary battery 1 of this embodiment, a second insulator 33 with a third through-hole 90 may be disposed between the lid member 7 and the first substrate portion 31a of the conductive member 31. The second insulator 33 may be provided as a pair separated on the positive-electrode side and the negative-electrode side or may be provided as a single integrated member. The second insulator 33 ensures insulation between the lid member 7 and the first substrate portion 31a of the conductive member 31. Preferably, the shaft portion 55 of the terminal 23 is fitted in close contact with the lid member 7 and the conductive member 31 through the third through-hole 90 of the second insulator 33. The positional relationship between the first through-hole 20 of the lid member 7, the second through-hole 60 of the conductive member 31, and the third through-hole 90 of the second insulator 33 is aligned in the Z-direction.

In the secondary battery 1 of this embodiment, the lid member 7 may optionally be provided with a gas vent valve 21 and a liquid injection port 17. After liquid injection, the liquid injection port 17 is sealed with a sealing plate 19.

In this embodiment, the current collector tabs 70 are electrically insulated from the outer case 3 by an insulating cover 34 disposed between the tabs 70 and the outer case 3. The insulating cover 34 may be fixed to the electrode assembly 5 with insulating tape 36. A terminal insulator 35 may be disposed between the terminal 23 and the lid member 7, thereby electrically insulating the terminal 23 from the lid member 7.

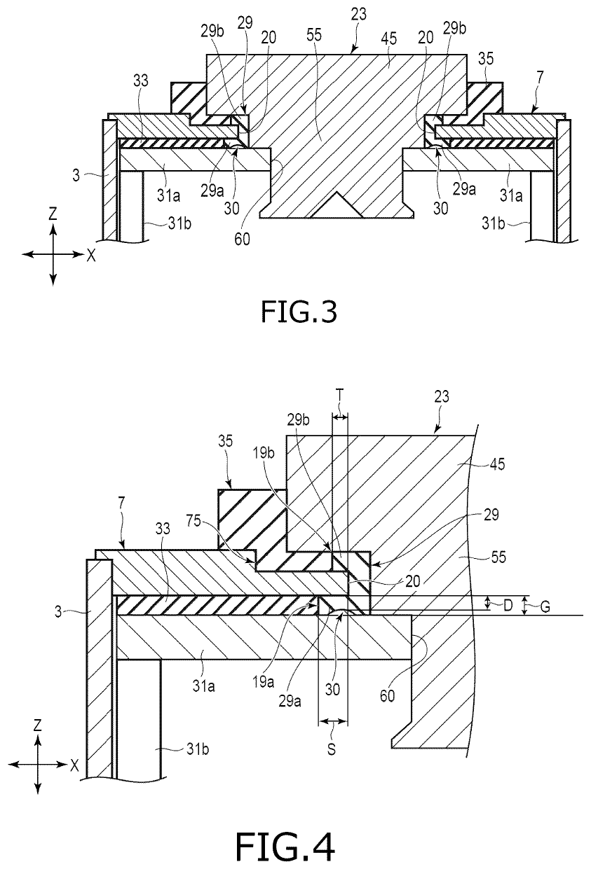

The structure around the terminal 23 in the secondary battery 1 of this embodiment will now be described with reference to FIG. 3, which is a cross-sectional view of the region around the terminal 23 along line I-I of FIG. 1 and viewed from the direction of the arrows. As described above, the shaft portion 55 of the terminal 23 is fitted in close contact with the lid member 7 with a cylindrical insulating gasket 29 (first insulating member). As shown in FIG. 3, the first insulating member 29 has a first flange portion 29a disposed on the lower side of the lid member 7 and a second flange portion 29b disposed on the upper side of the lid member 7. Since the first insulating member 29 is cylindrical, it is preferable that the first flange portion 29a and the second flange portion 29b be disposed over the entire circumference of the shaft portion 55 of the terminal 23; however, it suffices that they be provided on at least a part of the circumference.

Because the first insulating member 29 having the first flange portion 29a, close contact between the shaft portion 55 of the terminal 23 and the first through-hole 20 of the lid member 7 can be ensured on the lower side of the lid member 7, thereby ensuring hermeticity on the lower side of the lid member 7. Furthermore, because the first insulating member 29 also has the second flange portion 29b, close contact between the shaft portion 55 of the terminal 23 and the first through-hole 20 of the lid member 7 can be ensured on the upper side of the lid member 7, thereby ensuring hermeticity on the upper side of the lid member 7.

As shown in FIG. 3, the first flange portion 29a of the first insulating member 29 is fitted in contact with the first substrate portion 31a of the conductive member 31, specifically in contact with the top portion 30 of the first substrate portion 31a. The top portion 30 refers to a portion of the first substrate portion 31a that protrudes in the height direction (the Z-direction) of the secondary battery 1 and has a top.

The structure around the top portion 30 of the first substrate portion 31a will now be described with reference to FIG. 4. FIG. 4 is an enlarged cross-sectional view of the top portion 30 in FIG. 3. As shown in FIG. 4, the portion of the first flange portion 29a that is in contact with the top portion 30 has a thickness D that is smaller than a thickness G at a first end portion 19a of the first flange portion 29a. The “first end portion 19a” refers to an end portion of the first flange portion 29a that is spaced apart from the shaft portion 55 of the terminal 23. Since thickness D is smaller than thickness G, the first flange portion 29a is compressed to a greater degree in the Z-direction by the presence of the top portion 30 of the first substrate portion 31a.

The first flange portion 29a is compressed at a high compression ratio in the region where it is sandwiched between the top portion 30 and the lower surface of the lid member 7. FIG. 6 is a cross-sectional view of the region around the terminal 23 along line I-I in FIG. 1 and viewed from the direction of the arrows for a comparative example. As shown in FIG. 6, in the comparative example, the top portion 30 of the first substrate portion 31a is absent, and the surfaces of the first substrate portion 31a and the first flange portion 29a are in surface-to-surface contact. In such a case, the first flange portion 29a is compressed in the Z-direction where it is in surface-to-surface contact with the first substrate portion 31a.

As shown in FIG. 3, when the first substrate portion 31a includes the top portion 30, the compression ratio in the region of the first flange portion 29a having a thickness D that is thinner than the thickness G becomes greater than in the case where the first substrate portion 31a has no top portion, as illustrated in FIG. 6. Accordingly, even when an external impact is applied to the secondary battery 1, the compressed portion formed by the top portion 30 in the Z-direction prevents displacement of the first insulating member 29, and loosening of the first insulating member 29 due to such displacement can be prevented.

Furthermore, even if an external impact is applied to the secondary battery 1 and the first insulating member 29 is displaced in the width direction (the X-direction) or thickness direction (the Y-direction), the compressed portion of the first flange portion 29a formed by the top portion 30 functions as a stop, preventing loosening of the first insulating member 29. When multiple secondary batteries 1 are connected, a connection member is attached to the terminal 23. Vibration generated during the attachment of the connection member may apply force in the X-direction or the Y-direction to the secondary battery 1. However, even in this case, the compressed portion of the first flange portion 29a formed by the top portion 30 prevents loosening of the first insulating member 29.

Thus, in this embodiment, by suppressing displacement of the first insulating member 29 in both the Z-direction and the X-direction or the Y-direction, hermeticity between the lid member 7 and the terminal 23 can be reliably ensured by the first insulating member 29. Accordingly, a secondary battery 1 with reliable hermeticity can be provided.

In this embodiment, the top portion 30 is preferably formed by providing a protrusion on the first substrate portion 31a. Although the shape of the top portion 30 shown in FIGS. 3 and 4 is not limited, a cross-sectional arc shape having a top is preferred. Since the top portion 30 has an arcuate shape without sharp portion, concentration of compressive force on sharp portion of the first flange portion 29a can be suppressed, thereby preventing the first flange portion 29a from being damaged or perforated by such sharp portion. The protrusion may be made of the same material as the conductive member 31, or may be formed of a different material.

In this embodiment, the top portion 30 is formed in an annular shape coaxial with the second through-hole 60 and is disposed around the second through-hole 60 on the first substrate portion 31a. The top portion 30 is not limited to a continuous shape and may instead be disposed intermittently at multiple positions in the circumferential direction. The top portion 30 may be disposed at one or more locations.

In this embodiment, the top portion 30 is disposed in a region (region S) between the inner wall of the first through-hole 20 of the lid member 7 and the first end portion 19a of the first flange portion 29a, which is spaced apart from the shaft portion 55. Because the top portion 30 is positioned on the side of the first end portion 19a rather than on the inner wall of the first through-hole 20, the lower surface of the lid member 7 is disposed above the top portion 30. Accordingly, the first flange portion 29a can be clamped between the top portion 30 and the lower surface of the lid member 7, achieving a high compression ratio on the first flange portion 29a.

As described above, the thickness D of the portion of the first flange portion 29a that contacts the top portion 30 is smaller than the thickness G of the first flange portion 29a at the first end portion 19a. Specifically, the thickness D is 0.05 times or more and 0.5 times or less than the thickness G. When the thickness D is 0.05 times or more compared with the thickness G, the compression ratio of the first flange portion 29a at the top portion 30 becomes higher than the compression ratio at the first end portion 19a, thereby providing the functional advantage of having the first flange portion 29a in contact with the top portion 30.

On the other hand, when the thickness D is 0.5 times or less than the thickness G, the top portion 30 does not approach the lower surface of the lid member 7 excessively, thereby preventing contact between the two and avoiding short-circuiting of the secondary battery 1. A more preferred range is that the thickness D be 0.2 times or more and 0.5 times or less than the thickness G.

As shown in FIGS. 3 and 4, in the secondary battery 1 of this embodiment, it is preferable to dispose a second insulator 33 between the lid member 7 and the first substrate portion 31a of the conductive member 31. The second insulator 33 is disposed in contact with the first end portion 19a of the first flange portion 29a. As described above, when the terminal 23 is brought into close contact with the lid member 7, a load is applied to the head portion 45 of the terminal 23, and the shaft portion 55 of the terminal 23 is crimped to the lid member 7. During this crimping process, the shaft portion 55 expands in the width (X) direction or the thickness (Y) direction of the secondary battery 1. Here, the first end portion 19a of the first flange portion 29a, which is pressed in the X-direction or the Y-direction by the shaft portion 55 of the terminal 23, is in contact with the second insulator 33. As a result, force is applied from the first end portion 19a to the second insulator 33. The force applied from the first end portion 19a to the second insulator 33 returns as a reactive force from the second insulator 33 to the first end portion 19a. Thus, the first flange portion 29a receives forces from both the shaft portion 55 of the terminal 23 and from the second insulator 33, ensuring a high compression ratio in the X-direction or the Y-direction of the secondary battery 1. Accordingly, a secondary battery 1 with reliable hermeticity at the first insulating member 29 can be provided.

In the secondary battery 1 of this embodiment, it is preferable to dispose a terminal insulator 35 between the head portion 45 of the terminal 23 and the lid member 7. The terminal insulator 35 is disposed in contact with the second end portion 19b of the second flange portion 29b. Here, the second end portion 19b refers to an end portion of the second flange portion 29b that is spaced apart from the shaft portion 55 of the terminal 23.

As described above, during the crimping process in which the terminal 23 is brought into close contact with the lid member 7, the shaft portion 55 of the terminal 23 expands in the width (X) direction or the thickness (Y) direction of the secondary battery 1. Here, the second end portion 19b of the second flange portion 29b, which is pressed in the X-direction or the Y-direction by the shaft portion 55, is in contact with the terminal insulator 35, and therefore force is applied from the second end portion 19b to the terminal insulator 35. Thus, force is applied from the second end portion 19b to the terminal insulator 35, and the reactive force applied from the terminal insulator 35 returns to the second end portion 19b.

Accordingly, the second flange portion 29b receives forces from both the shaft portion 55 of the terminal 23 and from the terminal insulator 35, ensuring a high compression ratio in the X-direction or the Y-direction of the secondary battery 1. As a result, a secondary battery 1 with reliable hermeticity at the first insulating member 29 can be provided.

Furthermore, the lid member 7 preferably includes a stepped portion 75, and the terminal insulator 35 and the second flange portion 29b are disposed on the stepped portion 75.

It is preferable that the inner wall of the stepped portion 75 be in contact with the terminal insulator 35, thereby positioning the terminal insulator 35 in the width (X) direction or the thickness (Y) direction. Therefore, even when an external impact is applied to the secondary battery 1, displacement of the terminal insulator 35 in the X-direction or the Y-direction can be prevented. Moreover, because the second end portion 19b of the second flange portion 29b is in contact with the terminal insulator 35 whose displacement is prevented, any force applied from the second end portion 19b to the terminal insulator 35 returns sufficiently as a reactive force to the second end portion 19b. Thus, the hermeticity ensured by the first insulating member 29 can be further improved, allowing the provision of a secondary battery 1 with more reliable hermeticity.

The lengths of the first flange portion 29a and the second flange portion 29b of the first insulating member 29 will now be described. As shown in FIG. 4, in the width (X) direction or the thickness (Y) direction of the secondary battery 1, the maximum length S of the first flange portion 29a measured from the inner wall of the first through-hole 20 of the lid member 7 to the first end portion 19a is preferably 1.1 times or more and 2.0 times or less than the maximum length T of the second flange portion 29b measured from the inner wall of the first through-hole 20 to the second end portion 19b.

When the length S of the first flange portion 29a is 1.1 times or more compared with the length T of the second flange portion 29b, the length from the top portion 30 to the first end portion 19a of the first flange portion 29a is sufficiently large. Accordingly, even if an external impact is applied to the secondary battery 1 and the first insulating member 29 is displaced in the X-direction or the Y-direction, displacement of the first end portion 19a to the position of the top portion 30 can be suppressed. This prevents the first end portion 19a from passing through the compressed region of the first flange portion 29a formed by the top portion 30, thereby preventing the first insulating member 29 from becoming loosened, and ensuring hermeticity between the lid member 7 and the terminal 23 by means of the first insulating member 29.

As described above, because the length from the top portion 30 to the first end portion 19a of the first flange portion 29a is sufficiently secured, even if the first insulating member 29 is displaced in the X-direction or Y-direction, the first end portion 19a is prevented from passing through the compressed region of the first flange portion 29a formed by the top portion 30. When the length S of the first flange portion 29 a is 2.0 times or less compared with the length T of the second flange portion 29b, excessive increase of S relative to T can be avoided. That is, during the crimping process of the terminal 23, the difference between the loads applied to the first flange portion 29a and the second flange portion 29b can be prevented from becoming too large. As a result, the degree of close contact between the first flange portion 29a and the shaft portion 55 of the terminal 23, and that between the second flange portion 29b and the shaft portion 55, does not differ significantly, and hermeticity between the lid member 7 and the terminal 23 can be reliably ensured by the first insulating member 29. A more preferred range is that the length S be 1.5 times or more and 2.0 times or less relative to the length T.

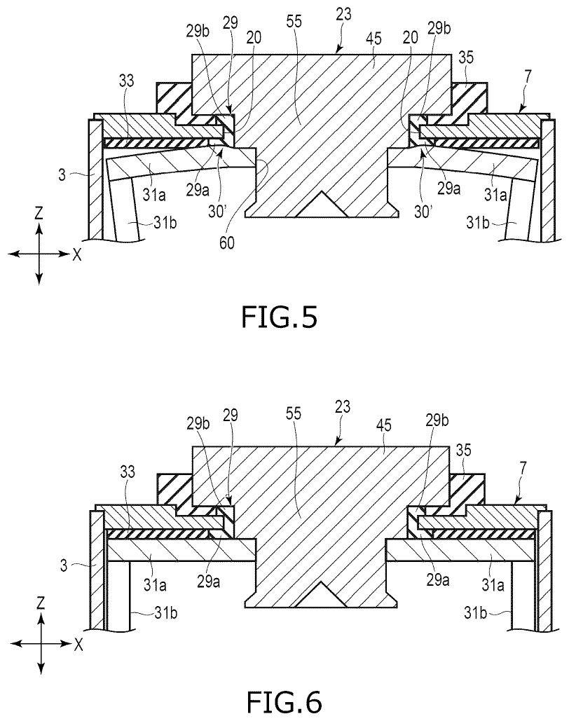

Next, a modified example of the secondary battery 1 according to this embodiment will be described with reference to FIG. 5. FIG. 5 is a cross-sectional view of the region around the terminal 23 along line I-I of FIG. 1 and viewed from the direction of the arrows for a modified example of the secondary battery 1 of the first embodiment. The point of difference between the modified example and the first embodiment lies in the method of forming the top portion 30′, while the other structural elements are the same as those of the secondary battery 1 of the first embodiment.

As shown in FIG. 5, the top portion 30′ in the modified example is formed by deforming the first substrate portion 31a of the conductive member 31. Specifically, during the crimping process of the terminal 23, the load applied to the head portion 45 of the terminal 23 is adjusted so as to deform the shaft portion 55. As the shaft portion 55 is deformed, the first substrate portion 31a in the vicinity of the first flange portion 29a is pushed upward in the height (Z) direction of the secondary battery 1, thereby forming the top portion 30′. Because the top portion 30′ can be formed solely by the crimping process of the terminal 23, the formation of the top portion 30′ is simplified, improving the manufacturability of the secondary battery 1.

In the modified example, the first substrate portion 31a of the conductive member 31 is deformed in the height (Z) direction of the secondary battery 1 relative to the lower surface of the lid member 7; however, this is not limiting. When a load is applied to the head portion 45 of the terminal 23, the first substrate portion 31a may be deformed depending on the magnitude of the load.

In such a case, the conductive member 31 is positioned closer to the electrode assembly 5, thereby enabling the conductive member 31 to prevent displacement of the electrode assembly 5 caused by external impact.

In the secondary battery 1 of the first embodiment described above, because the first flange portion 29a is disposed in contact with the top portion 30 of the first substrate portion 31a, the thickness D of the portion of the first flange portion 29a that contacts the top portion 30 is smaller than the thickness G of the first flange portion 29a at the first end portion 19a. Since the thickness D is smaller than thickness G, the first flange portion 29a is compressed in the height (Z) direction of the secondary battery 1 by the top portion 30 of the first substrate portion 31a.

The first flange portion 29a is compressed at a high compression ratio in the region where it is sandwiched between the top portion 30 and the lower surface of the lid member 7. In other words, compared with the case where the first substrate portion 31a has no top portion 30, the presence of the top portion 30 increases the compression ratio of the first flange portion 29a. Accordingly, even when an external impact is applied to the secondary battery 1, the compressed portion in the Z-direction formed by the top portion 30 prevents displacement in the Z-direction of the first insulating member 29, thereby preventing the first insulating member 29 from becoming loosened due to such displacement.

Even if an external impact is applied to the secondary battery 1 and, in an unlikely event, the first insulating member 29 is displaced in the width (X) direction or the thickness (Y) direction, the compressed portion of the first flange portion 29a functions as a stop against such displacement, thereby preventing the first insulating member 29 from becoming loosened. When multiple secondary batteries 1 are connected, a connection member is attached to the terminal 23, and vibration generated during the attachment of the connection member may apply significant force in the X-direction or the Y-direction. Even in such a case, the compressed portion of the first flange portion 29a prevents loosening of the first insulating member 29. Thus, in this embodiment, because displacement of the first insulating member 29 is prevented both in the height (Z) direction and in the width (X) or the thickness (Y) direction, hermeticity between the lid member 7 and the terminal 23 can be reliably ensured by the first insulating member 29. Accordingly, a secondary battery 1 with ensured hermeticity can be provided.

Several embodiments of the present invention have been described; however, these embodiments are presented merely as examples and are not intended to limit the scope of the invention. These embodiments may be implemented in various other forms, and various omissions, substitutions, and modifications may be made without departing from the spirit of the invention. Such embodiments and modifications fall within the scope and spirit of the invention and are also included within the invention described in the claims and the equivalents thereof.

What is claimed is:

1. A secondary battery, comprising:
an outer case including an aperture portion;
an electrode assembly in the outer case;
a lid member disposed at the aperture portion and having a first through-hole;
a conductive member disposed between the electrode assembly and the lid member and having a substrate portion provided with a second through-hole;
a terminal having a shaft portion in the first through-hole and the second through-hole; and
a first insulating member having a first flange portion disposed on a lower side of the lid member and a second flange portion disposed on an upper side of the lid member, wherein
the substrate portion of the conductive member includes a top portion that is in contact with the first flange portion.

2. The secondary battery of claim 1, wherein
the top portion is disposed in a region between an inner wall of the first through-hole and a first end portion of the first flange portion that is spaced apart from the shaft portion.

3. The secondary battery of claim 2, wherein
a thickness of the portion of the first flange portion that is in contact with the top portion is 0.05 times or more and 0.5 times or less than a thickness of the first flange portion at the first end portion.

4. The secondary battery of claim 2, further comprising:
a second insulator that is disposed between the lid member and the substrate portion of the conductive member and is in contact with the first end portion.

5. The secondary battery of claim 2, wherein
the terminal includes a head portion connected to the shaft portion and disposed above the second flange portion;
a terminal insulator is disposed between the lid member and the head portion of the terminal; and
a second end portion of the second flange portion that is spaced apart from the shaft portion is in contact with the terminal insulator.

6. The secondary battery of claim 1, wherein
the lid member includes a stepped portion, and the second flange portion is disposed on the stepped portion.

7. The secondary battery of claim 2, wherein
the lid member includes a stepped portion, and the second flange portion is disposed on the stepped portion.

8. The secondary battery of claim 5, wherein
a length of the first flange portion measured from the inner wall of the first through-hole to the first end portion is 1.1 times or more and 2.0 times or less than a length of the second flange portion measured from the inner wall of the first through-hole to the second end portion.
